(19) United States
(12) Patent Application Publication
(10) Pub. No.: US 2018/0114284 A1
(43) Pub. Date: Apr. 26, 2018

(54) RECIPE SUGGESTION BASED ON CUSTOMER FEEDBACK

(71) Applicant: International Business Machines Corporation, Armonk, NY (US)

(72) Inventors: Jeremy A. Greenberger, Raleigh, NC (US); Mary D. Swift, Rochester, NY (US)

(21) Appl. No.: 15/299,636

(22) Filed: Oct. 21, 2016

(51) Int. Cl. G06Q 50/12; G06Q 30/02; G06F 17/30

(52) U.S. Cl. CPC G06Q 50/12; G06F 17/30867; G06Q 30/0282

(57) ABSTRACT

Analysis of feedback from consumers in posts regarding food products of an establishment, to aid in making recipe suggestions for the food products.

### BACKGROUND

The present invention relates to analysis of customer feedback, and more specifically to analysis of customer feedback for recipe suggestion.

There are numerous outlets for restaurant-goers to provide feedback. Certain websites provide customers a place to voice their opinion regarding their meal at an establishment. Unless an establishment, such as a restaurant, specifically reads each and every comment posted to the website, the restaurant is not made aware of food-specific feedback provided by restaurant-goers or users.

### SUMMARY

According to one embodiment of the present invention, a method of analysis of feedback from consumers of food products of an establishment to aid in making recipe suggestions for the food products disclosed. The method comprising the steps of: a computer searching for one or more posts to a website; and the computer determining whether a post is related to at least one food product of an establishment. When the at least one food product in the post is related to the at least one food product of the establishment, the computer: determining a sentiment of the post and at least one topic of the post; generating a score for the sentiment and the at least one topic of the post; and generating a modification to the at least one recipe when the score is less than a threshold, the modifications based on the post, and sending the modification to the at least one recipe and the post to the establishment.

According to an embodiment of the present invention, a computer program product for analysis of feedback from consumers of food products of an establishment to aid in making recipe suggestions for the food products disclosed. The computer program product comprising a computer comprising at least one processor, one or more memories, one or more computer readable storage media, the computer program product comprising a computer readable storage medium having program instructions embodied therewith. The program instructions executable by the computer to perform a method comprising: searching, by the computer, for one or more posts to a website; and determining, by the computer, whether a post is related to at least one food product of an establishment. When the at least one food product in the post is related to the at least one food product of the establishment, the computer: determining, by the computer, sentiment of the post and at least one topic of the post; generating, by the computer, a score for the sentiment and the at least one topic of the post; and generating, by the computer, a modification to the at least one recipe when the score is less than a threshold, the modifications based on the post, and sending, by the computer, the modification to the at least one recipe and the post to the establishment.

According to an embodiment of the present invention, a computer system for analysis of feedback from consumers of food products of an establishment to aid in making recipe suggestions for the food products is disclosed. The computer system comprising a computer comprising at least one processor, one or more memories, one or more computer readable storage media having program instructions executable by the computer to perform the program instructions. The program instructions comprising: searching, by the computer, for one or more posts to a website; and determining, by the computer, whether a post is related to at least one food product of an establishment. When the at least one food product in the post is related to the at least one food product of the establishment, the computer: determining, by the computer, sentiment of the post and at least one topic of the post; generating, by the computer, a score for the sentiment and the at least one topic of the post; and generating, by the computer, a modification to the at least one recipe when the score is less than a threshold, the modifications based on the post, and sending, by the computer, the modification to the at least one recipe and the post to the establishment.

According to another embodiment of the present invention, a method for analysis of feedback from consumers of food products of an establishment to aid in making recipe suggestions for the food products is disclosed. The method comprising the steps of: a computer obtaining feedback from consumers from one or more posts to an establishment specific application; the computer determining whether the feedback of the one or more posts is related to at least one food product of the establishment; when the at least one food product in the feedback corresponds to at least one recipe in a repository associated with the establishment, the computer: determining sentiment of the one or more posts and at least one topic of the post; and generating a score for the sentiment and the at least one topic of the post.

### BRIEF DESCRIPTION OF THE DRAWINGS

FIG. 1 depicts a cloud computing node according to an embodiment of the present invention.

FIG. 2 depicts abstraction model layers according to an embodiment of the present invention.

FIG. 3 shows a flow diagram of analysis of feedback of an establishment to aid in making recipe suggestions.

FIG. 4 illustrates a block diagram of an exemplary system architecture, including a natural language processing system, configured to use reviews to rank food products consumed or purchased at an establishment, in accordance with embodiments of the present disclosure.

### DETAILED DESCRIPTION

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models

Characteristics are defined as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are defined as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are defined as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

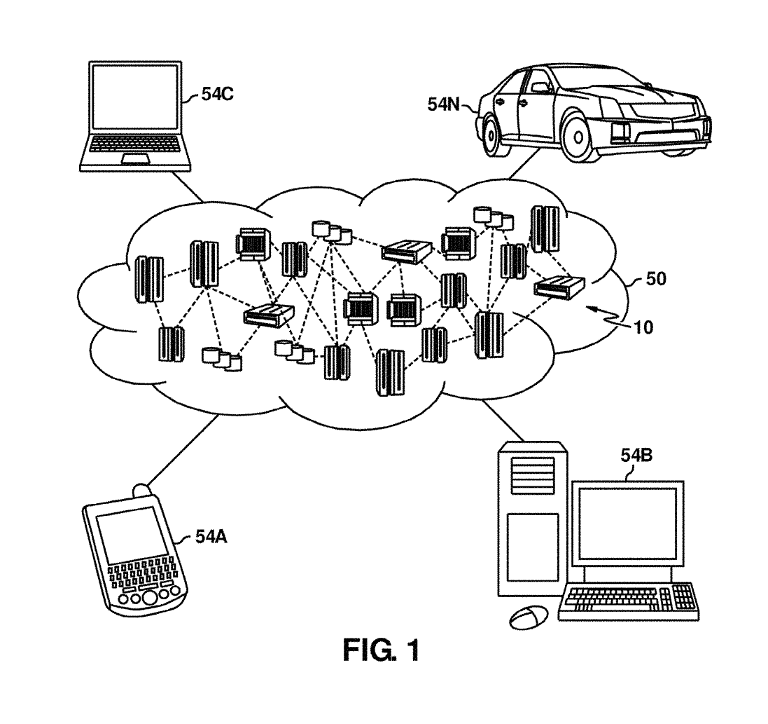

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer MB, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

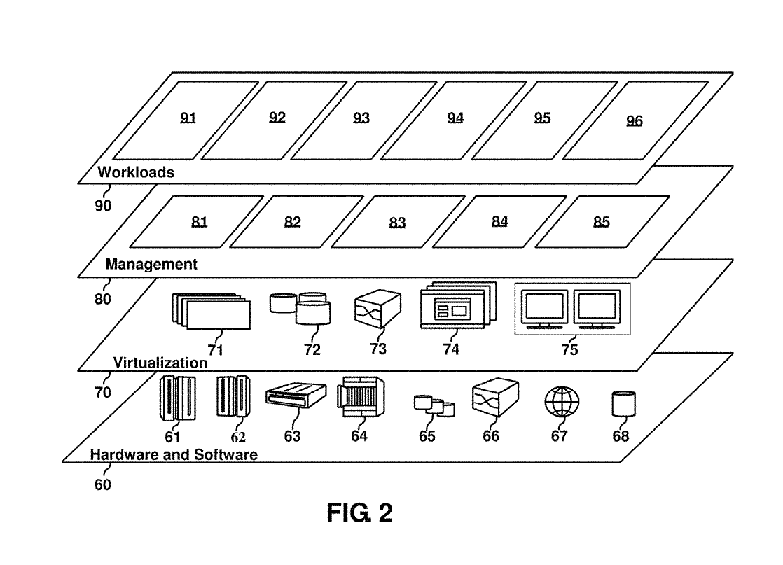

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and consumer feedback processing 96.

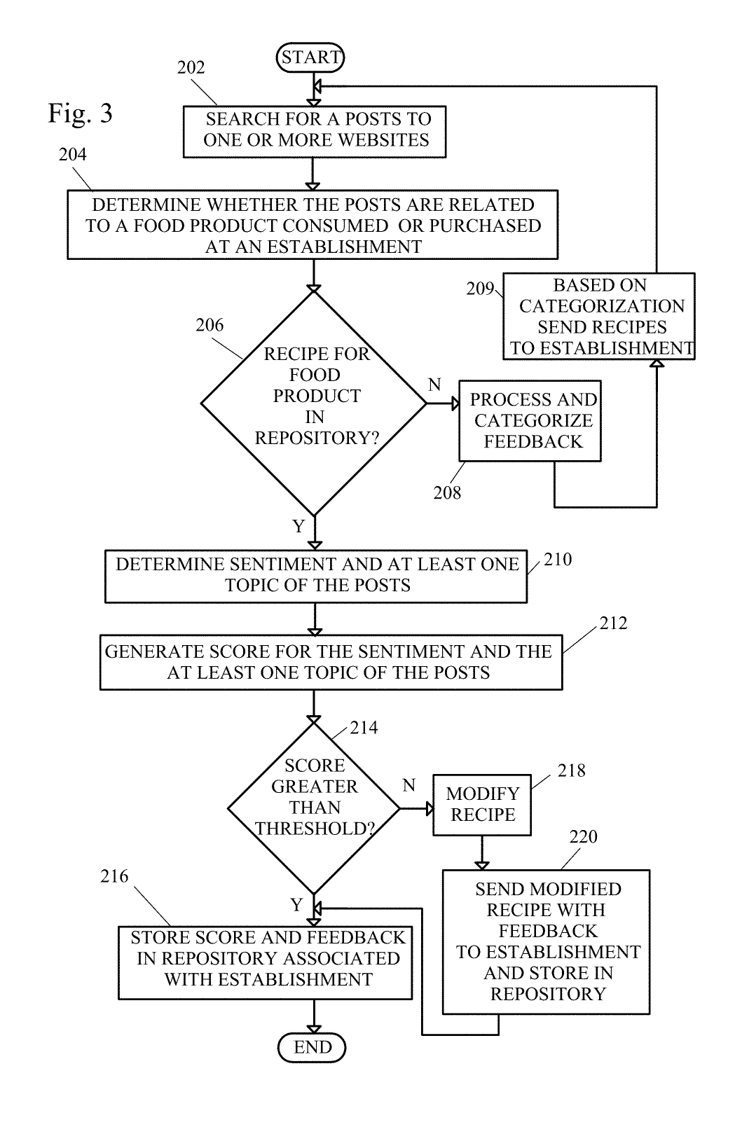

It should be noted that prior to FIG. 3, an establishment may register with a consumer feedback processing system that suggests recipes based on customer feedback and searches for the particular establishment based their company name or other distinguishing information such as address or logo. Additionally, the establishment may register their menu and associated recipes with the consumer feedback system 96 as well as what chefs work at the establishment and when specific chefs are working to prepare food products. In addition, an organization with establishments at two or more geographic locations may register each location.

In an alternate embodiment, the restaurant or establishment may be have their own application with an application program interface (API) which can collect comments and feedback from consumers which are provided as input to the consumer feedback processing system 96.

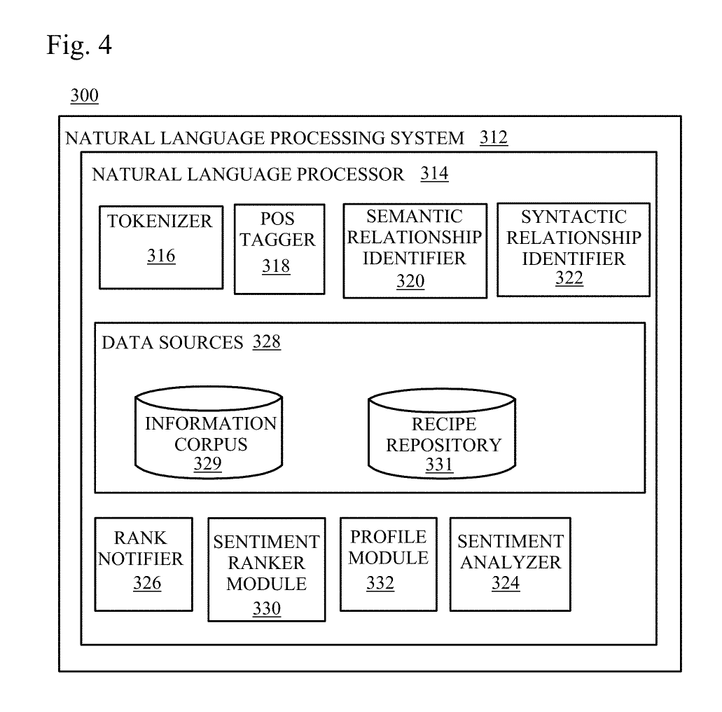

Referring now to FIG. 4, shown is a block diagram of an exemplary system architecture 300, including a natural language processing system 312 of the consumer feedback processing system 96, configured to use posts from one or more websites to rank food products of an establishment, in accordance with embodiments of the present disclosure. Chefs which prepared the food products as well as the recipes used to prepare the food products may additionally be ranked in accordance with embodiments of the present disclosure. In some embodiments, electronic posts or webpages (containing reviews of food products of an establishment to be analyzed) may be provided to the natural language processing system 312 of the consumer feedback processing system 96.

The natural language processing system 312 may analyze received posts containing reviews to aid in the analysis of the relative importance of the preparation and recipes used for food products for the establishment's consideration. In some embodiments, the natural language processing system 312 may include a natural language processor 314, data sources 328, a rank notifier 326, profile module 332, and a sentiment ranker module 330.

The natural language processor 314 may be a computer module that analyzes the posts and other electronic documents containing reviews of food products of the establishment. The natural language processor 314 may perform various methods and techniques for analyzing electronic documents (e.g., syntactic analysis, semantic analysis, etc.). The natural language processor 314 may be configured to recognize and analyze any number of natural languages. In some embodiments, the natural language processor 314 may parse passages of the documents. Further, the natural language processor 314 may include various modules to perform analyses of the posts. These modules may include, but are not limited to, a tokenizer 316, a part-of-speech (POS) tagger 318, a semantic relationship identifier 320, a syntactic relationship identifier 322, profile module 332, and sentiment analyzer 324.

In some embodiments, the tokenizer 316 may be a computer module that performs lexical analysis. The tokenizer 316 may convert a sequence of characters into a sequence of tokens. A token may be a string of characters included in an electronic document and categorized as a meaningful symbol. Further, in some embodiments, the tokenizer 316 may identify word boundaries in an electronic document and break any text passages within the document into their component text elements, such as words, multiword tokens, numbers, and punctuation marks. In some embodiments, the tokenizer 316 may receive a string of characters, identify the lexemes in the string, and categorize them into tokens.

Consistent with various embodiments, the POS tagger 318 may be a computer module that marks up a word in passages to correspond to a particular part of speech. The POS tagger 318 may read a passage or other text in natural language and assign a part of speech to each word or other token. The POS tagger 318 may determine the part of speech to which a word (or other text element) corresponds based on the definition of the word and the context of the word. The context of a word may be based on its relationship with adjacent and related words in a phrase, sentence, or paragraph. In some embodiments, the context of a word may be dependent on one or more previously analyzed electronic documents (e.g., the content of one post may shed light on the meaning of text elements in another post regarding food products of an establishment, particularly if they are posts of the same food products) or profile generated to correspond to the establishment or individual chefs at the establishment. Examples of parts of speech that may be assigned to words include, but are not limited to, nouns, verbs, adjectives, adverbs, and the like. Examples of other part of speech categories that POS tagger 318 may assign include, but are not limited to, comparative or superlative adverbs, wh-adverbs, conjunctions, determiners, negative particles, possessive markers, prepositions, wh-pronouns, and the like. In some embodiments, the POS tagger 318 may tag or otherwise annotate tokens of a passage with part of speech categories. In some embodiments, the POS tagger 318 may tag tokens or words of a passage to be parsed by other components of the natural language processing system 312.

In some embodiments, the semantic relationship identifier 320 may be a computer module that is configured to identify semantic relationships of recognized text elements (e.g., words, phrases) in documents. In some embodiments, the semantic relationship identifier 320 may determine functional dependencies between entities and other semantic relationships. For example, a semantic relationship between a specific food product and an associated element of the corresponding recipe being used by the establishment.

Consistent with various embodiments, the syntactic relationship identifier 322 may be a computer module that is configured to identify syntactic relationships in a passage composed of tokens. The syntactic relationship identifier 322 may determine the grammatical structure of sentences such as, for example, which groups of words are associated as phrases and which word is the subject or object of a verb. The syntactic relationship identifier 322 may conform to formal grammar.

Consistent with various embodiments, the sentiment analyzer 324 may be a computer module that is configured to identify and categorize the sentiments associated with tokens of interest. In some embodiments, the sentiment analyzer may be configured to identify, within text passages, and annotate keywords that are preselected as high quality indicators of sentiment polarity (e.g., indicators of positive sentiment could include brilliant, excellent, delicious, or fantastic). Various tools and algorithms may be used by the sentiment analyzer 324 as are known to those skilled in the art (e.g., Naïve Bayes lexical model). The quality indicators of sentiment polarity may be correlated with specific user profiles within an establishment or the profile for the establishment.

In some embodiments, the natural language processor 314 may be a computer module that may parse a document and generate corresponding data structures for one or more portions of the document or posts. For example, in response to receiving a set of posts from a website that includes a collection of posts or reviews of food products at the natural language processing system 312, the natural language processor 314 may output parsed text elements from the product reviews as data structures. In some embodiments, a parsed text element may be represented in the form of a parse tree or other graph structure. To generate the parsed text element, the natural language processor 314 may trigger computer modules 316-324.

In some embodiments, the output of the natural language processor 314 may be stored as an information corpus 329 in one or more data sources 328. In some embodiments, data sources 328 may include data warehouses, information corpora, data models, document repositories, and recipe repositories. The information corpus 329 may enable data storage and retrieval. In some embodiments, the information corpus 329 may be a storage mechanism that houses a standardized, consistent, clean, and integrated copy of the ingested and parsed posts or reviews of food products. Data stored in the information corpus 329 may be structured in a way to specifically address analytic requirements. For example, the information corpus 329 may store the ingested food product posts or reviews based on groups of related products (e.g., products of the same type) in order to make ranking product features easier. In some embodiments, the information corpus 329 may be a relational database. The information corpus 329 may incorporate a recipe repository 331 or the recipe repository 331 may be part of the data sources 328. The recipe repository 331 stores recipes used by the establishment for their food products and may additionally contain other recipes to be suggested based on sentiment analysis of posts from consumers.

In some embodiments, the natural language processing system 312 may include a sentiment ranker module 330. The sentiment ranker module 330 may be a computer module that is configured to generate sentiment scores for specific forms of features or qualities based on the analysis of annotated reviews or posts of the food product of an establishment. The sentiment ranker module 330 may be further configured to rank the features based on these sentiment scores.

The rank notifier 326 may be a computer module that is configured to notify users of feature rankings determined by the sentiment ranker module 330. In some embodiments, the rank notifier 326 may communicate with a rank notification receiver module.

The profile module 332 may be a computer module that is configured to establish and maintain profiles of chefs at establishments and/or a profile of the establishment. The profile of the chefs at the establishment may include qualities and information that allows the posts to be attributed or correlated to these profiles. The profile module 332 may store locations of establishments, sentiment and topic scores, and feedback.

FIG. 3 shows a flow diagram of analysis of feedback of an establishment to aid in making recipe suggestions.

In a first step (step 202), a consumer feedback processing system 96 associated with a workload layer of the cloud computing environment searches for one or more posts to one or more websites. For example, the website may be a site that enables a user to search for or submit a review for an establishment, or a social networking site. The search may be conducting through web crawling or other methods. Feedback from consumers can be attained from posts on various review and social networking sites, from an online survey, posts from sites specific to food reviews, and from an establishment specific application which collects feedback.

The posts are analyzed to determine posts that are related to a food product associated with an establishment (step 204) e.g. purchased or consumed at the establishment. The establishment may be a company or store that that prepares, serves and or sells food, for example a restaurant. It should be noted that if the post is related to a food product consumed at the establishment, but is not specific to a singular, specific dish and recipe, the feedback may be associated with all dishes and associated recipes that meet the characteristics described in the post. The characteristics may be determined, for example by natural language processing. For example, if a post or feedback is “the chicken was overcooked” and does not provide information regarding which dish, and four chicken dishes are present on the menu, the feedback may be applied to each of the dishes and their associated recipes.

If the food product in the post is not for a recipe stored in the repository (step 206), the feedback is processed, for example using natural language processing (NLP) and module for determining location context to determine content and context of the feedback. The feedback, based on the processing is categorized (step 208). Recipes regarding the categorization of the feedback are suggested and provided to the establishment (step 209) and the method returns to step 202. For example, if the feedback is “there are not any vegetarian options on the menu”, the feedback may be categorized as “vegetarian” and vegetarian recipes may be provided by a technology platform that uses natural language processing and machine learning to reveal location context from large amounts of unstructured data such as core food science, ingredient pairings, amounts of ingredients that are generally used, and the steps that are generally taken across various preparations and human psychology as well as established recipes as described below.

If the food product in the post is for a recipe stored in the repository and associated with the establishment (step 206), a sentiment of the post and at least one topic of the post is determined (step 210). The determination may be made by analyzing the sentiment, content, and context of the post. The content being what the consumer was referring to within the post. The context being the time of day the food product was served, number of consumers in the party, location of the establishment, etc. The sentiment being whether the consumer provided positive, neutral, or negative feedback. The content and context may be determined using Natural Language Processing (NLP), and sentiment analysis may be used to determine the sentiment of the post, for example using a consumer feedback processing system 96.

The consumer feedback processing system 96 may include a platform that uses natural language processing and machine learning to reveal location context from large amounts of unstructured data such as core food science, ingredient pairings, amounts of ingredients that are generally used, and the steps that are generally taken across various preparations and human psychology as well as established recipes. The consumer feedback processing system can also generate step by step instructions for each recipe.

The topic of the posts may be, but is not limited to quality of the ingredients in the food product, quantity of an ingredient within the food product, a process or technique employed to prepare the food product, temperature at which the food product was served; and absence of an ingredient within the food product.

A score is generated for the sentiment and the at least one topic of the post (step 212). For example a score may be generated for, but not limited to specific portions of the topic such as: an item (e.g. a specific food product), menu (e.g. suggestions regarding the entire menu); method or technique used to prepare the food product (e.g. frying, sautéing, etc.), a temperature (e.g. cooking temperature or temperature at which the food product was served to the consumer), creativity, and sentiment (e.g. positive, negative or neutral).

In one embodiment, an overall sentiment score may be calculated for the post as a whole. In an alternate embodiment, a sentiment score may be calculated for each portion of the post or the individual topics in the post.

If the score of the post is greater than a threshold (step 214), the score and feedback are stored in a repository and associated with the establishment (step 216) and the method ends. Additionally, a notification may be sent to the establishment for and the feedback may be viewed by the establishment.

In one embodiment, the overall score is compared to the threshold. In an alternate embodiment, the score of each portion of each topic of the post may be compared to the threshold.

The threshold may be predetermined. The threshold may be set by the establishment.

If the score of the post is not greater than a threshold (step 214), the recipe associated with the food product of the post is modified (step 218), for example using the consumer feedback processing system 96. The modification may include but is not limited to: suggesting alternate ingredients, removal of ingredients or alteration of techniques based on the score of the post.

The modified recipe with feedback is stored associated with the establishment in a repository, and the modified recipe with feedback is sent to the establishment for viewing (step 220) and the method ends. The feedback may additionally include the context of the feedback, for example including the date and time in which the food product would have been consumed by the consumer.

Based on the feedback and the modified recipe, the establishment may then decide whether to alter or accept the altered recipe for their menu as well as determine what chef at the establishment may have prepared the food product for the consumer.

It should be noted that the consumer feedback processing system 96 may additionally provide, through analytics, information regarding a total number of consumers who have provided a negative sentiment towards a specific food product/recipe within a certain time period, so as to exclude posts that may represent outliers. Additionally, specific consumers who repeatedly visit establishments and their associated posts regarding food products may be monitored to determine whether the modification of the recipe was successful. The posts for a specific establishment may be filtered based on time, date and location of the post.

Alternatively, if chefs at an establishment provide input regarding when they are working at the establishment, the consumer feedback processing system 96 may also propose which of the chefs may have prepared the food product identified in the at least one post based on context of the post. Additionally, through analytics, information regarding a total number of consumers who have provided a negative sentiment towards a specific food product/recipe prepared by a specific chef may be provided to the establishment.

While the method above is described relative to one post, a plurality of posts for an establishment may be aggregated and at least one topic and sentiment score for the aggregate posts may be determined.

In a first example, Vic's Italian Restaurant has registered with a consumer feedback processing system 96. The restaurant owner specifies social media accounts (e.g. Facebook, Twitter, Instagram) to monitor for customer feedback. In one embodiment, a chef can sign into the system to indicate that he/she is the one cooking.

The consumer feedback processing system 96 finds a post from a first user, where they complained that they did not like the Chicken Pompeii because they felt it was too spicy. The consumer feedback processing system 96 analyzes the data of the post and can match the feedback with a chef of the establishment based on the time and location the person posting the feedback. For example, the first user left a comment at 8 pm when she was present in the restaurant, and the consumer feedback processing system 96 assigns a degree of confidence that chef Luigi prepared this dish. Based on the feedback and sentiment of the comments left by the first user, the system suggests an alteration of the recipe, such as substituting crushed red pepper for the jalapenos, or using less hot sauce in the Chicken Pompeii. This suggestion can be forwarded to chef Luigi at Vic's Restaurant.

In another example, the consumer feedback processing system 96 processes data from multiple consumers to understand how the chef cooks. For example, this system can become aware that many consumers have complained about a particular veal dish. The consumer feedback processing system 96 can determine why the consumers did not like it based on the feedback. The consumer feedback processing system 96, based on the feedback, can change recipes for the future to avoid making veal, provide an educational video on how to cook veal or recommend a particular chef (if more than one chef works at the establishment) to cook recipes with veal. Therefore, an establishment may be provided with information regarding how each of the chefs of the establishment cooks and prepares different dishes on the menu. In an alternate embodiment, an establishment can set a threshold of how many times a chef can poorly cook an item on the menu and when that limit is reached, that menu item may be removed from the menu of the establishment.

In another example, a consumer has posted that there is a lack of vegetarian options at a specific establishment. The consumer feedback processing system 96 may suggest a vegetarian recipe that is within the style of cooking present at the establishment for the menu. The lack of vegetarian options may be identified as a topic of the post.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for analysis of feedback from consumers of food products of an establishment to aid in making recipe suggestions for the establishment by a natural language processing system, the natural language processing system comprising: a computer comprising at least a natural language processor in communication with data sources, the natural language processor comprising at least a semantic relationship identifier and a sentiment analyzer, the method comprising the steps of:
the computer searching for one or more posts to a website for the establishment;
for a post regarding the establishment, the computer:
determining sentiment regarding an absence of a food product not currently served at the establishment and not present on the menu of the establishment within the post regarding the establishment;
generating a new recipe to provide the food product to be served at the establishment which is not currently present in a menu of the establishment prior to the posts to the website wherein generating the new recipe is based on the determined sentiment regarding the absence of the food product not currently being served; and
sending the new recipe used to prepare the food product not present on the menu prior to the posts to the website to the establishment.

2. The method of claim 1, wherein the post further comprises data selected from a group consisting of: a quality of an ingredient in the food product, a quantity of an ingredient in the food product, a process employed to prepare the food product, and a temperature at which the food product was served.

3. (canceled)

4. The method of claim 1, wherein the sentiment is determined by analyzing context and content of the post.

5. The method of claim 4, wherein the context comprises a time of day the food product was served.

6. The method of claim 5, further comprising the steps of the computer:
determining at least one individual registered with the establishment which prepared the food product based on the time of day the food product was served; and
associating the post with the at least one individual registered with the establishment.

7. (canceled)

8. A computer program product for analysis of feedback from consumers of food products of an establishment to aid in making recipe suggestions for the establishment by a natural language processing system, the natural language processing system comprising a computer comprising at least one natural language processor, one or more memories, one or more computer readable storage media, the natural language processor comprising at least a semantic relationship identifier and a sentiment analyzer, the computer program product comprising a computer readable storage medium having program instructions embodied therewith, the program instructions executable by the computer to perform a method comprising:
searching, by the computer, for one or more posts to a website for the establishment;
for a post regarding the establishment:
determining, by the computer, sentiment regarding an absence of a food product not currently served at the establishment and not present on the menu of the establishment within the post regarding the establishment;
generating, by the computer, a new recipe to provide a food product to be served at the establishment which is not currently present on the menu of the establishment prior to the posts to the website wherein generating the new recipe is based on the determined sentiment regarding the absence of the food product not currently being served; and
sending, by the computer, the new recipe used to prepare the food product not present on the menu prior to the posts to the website to the establishment.

9. The computer program product of claim 8, wherein the post further comprises data selected from a group consisting of: a quality of an ingredient in the food product, a quantity of an ingredient in the food product, a process employed to prepare the food product, and a temperature at which the food product was served.

10. (canceled)

11. The computer program product of claim 8, wherein the sentiment is determined by the computer by analyzing context and content of the post.

12. The computer program product of claim 11, wherein the context comprises a time of day the food product was served.

13. The computer program product of claim 12, further comprising the program instructions of:
determining, by the computer, at least one individual registered with the establishment which prepared the food product based on the time of the food product was served; and
associating, by the computer, the post with the at least one individual registered with the establishment.

14. (canceled)

15. A computer system for analysis of feedback from consumers of food products of an establishment to aid in making recipe suggestions for the establishment by a natural language processing system, the natural language processing system of the computer system comprising a computer comprising at least one natural language processor, one or more memories, one or more computer readable storage media having program instructions executable by the computer to perform the program instructions, the natural language processor comprising at least a semantic relationship identifier and a sentiment analyzer, the computer system comprising:
searching, by the computer, for one or more posts to a website for the establishment;
for a post regarding the establishment:
determining, by the computer, sentiment regarding an absence of a food product not currently served at the establishment and not present on the menu of the establishment within the post regarding the establishment;
generating, by the computer, a new recipe to provide a food product to be served at the establishment which is not currently present on the menu of the establishment prior to the posts to the website wherein generating the new recipe is based on the determined sentiment regarding the absence of the food product not currently being served; and
sending, by the computer, the new recipe used to prepare the food product not present on the menu prior to the posts to the website to the establishment.

16. The computer system of claim 15, wherein the post further comprises data selected from a group consisting of: a quality of an ingredient in the food product, a quantity of an ingredient in the food product, a process employed to prepare the food product, and a temperature at which the food product was served.

17. (canceled)

18. The computer system of claim 15, wherein the sentiment is determined by the computer by analyzing context and content of the post.

19. The computer system of claim 18, wherein the context comprises a time of day the food product was served.

20. The computer system of claim 19, further comprising the program instructions of:
determining, by the computer, at least one individual registered with the establishment which prepared the food product based on the time of day the food product was served; and
associating, by the computer, the post with the at least one individual registered with the establishment.
